(19) United States
(12) Patent Application Publication
(10) Pub. No.: US 2014/0217927 A1
(43) Pub. Date: Aug. 7, 2014

(54) TEMPERATURE DEPENDENT HYBRID LIGHT BULB

(71) Applicant: Joseph Patrick Quinn, Norfolk, MA (US)

(72) Inventor: Joseph Patrick Quinn, Norfolk, MA (US)

(21) Appl. No.: 14/145,838

(22) Filed: Dec. 31, 2013

Related U.S. Application Data
(60) Provisional application No. 61/747,484, filed on Dec. 31, 2012.

(51) Int. Cl. H05B 41/36

(52) U.S. Cl. CPC H05B 41/36
USPC 315/313

(57) ABSTRACT

A hybrid light bulb is configured to automatically select a low heat emitting (low power) mode such as a CFL bulb portion when ambient temperature is above a predetermined threshold, and to select a high heat emitting (conventional incandescent or halogen bulb) portion when ambient temperature is below the predetermined threshold

### CROSS-REFERENCE TO RELATED APPLICATIONS

The present application claims priority to U.S. Provisional Patent Application No. 61/747,484, filed Dec. 31, 2012 entitled TEMPERATURE DEPENDENT HYBRID LIGHT BULB, which is incorporated herein by reference in its entirety.

### TECHNICAL FIELD

The present disclosure relates to lighting devices and, more particularly, to electronically controlled lighting devices.

### BACKGROUND

Power consumed by a light bulb that is not converted to light is dissipated as heat. When determining the efficiency of a light bulb, the heat dissipated from the light bulb is generally considered to be wasted power. High efficiency light bulbs, such as compact florescent lamps (CFLs) do not emit as much heat as conventional light bulbs, such as incandescent bulbs, and halogen lamps, for example. However, a large number of consumers prefer the light qualities of the less efficient conventional bulbs such as incandescent bulbs and halogen bulbs. In some situations, the heat released from the less efficient conventional bulbs may not be wasted because it may help to warm a room, for example. In these situations, the use of conventional bulbs may not be inefficient, especially in an environment where users would prefer the light qualities of incandescent bulbs or halogen bulbs.

### SUMMARY

Heat emitted from a light bulb is generally considered to be wasted energy. However, that is not always the case. For example, in some situations the heat emitted from an incandescent or halogen light bulb may be useful heat. In a cold ambient environment, a user may desire a heat emitting light bulb such as an incandescent bulb or a halogen bulb. A heat emitting bulb, such as a reading lamp that is located near a person, may save energy by providing enough extra heat in the vicinity of the person to reduce calls for heat from a conventional heating system. For example, the user of the heat emitting light may not need to adjust a thermostat, or the thermostat may not need to signal for heat from the conventional heating system as frequently as it otherwise would. Even if the heat emitted from a conventional light bulb is not delivered as efficiently as from other heat sources, the benefit of heat provided by the conventional light bulb is combined with the benefit of improved light quality that can be enjoyed when heat emissions are not undesirable.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIGS. 1A and 1B are conceptual illustrations showing an example of a conventional 3-way light bulb and a conventional 3-way light bulb socket according to the PRIOR ART.

FIG. 2 is a cross-sectional view of a hybrid light bulb including timer circuitry as described in the PRIOR ART.

FIG. 3 is a circuit diagram illustrating hybrid light bulb circuitry as described in the PRIOR ART.

FIG. 4 is a circuit diagram illustrating temperature dependent hybrid light bulb circuitry according to aspects of the present disclosure.

FIG. 5 is process flow diagram illustrating a method for controlling a temperature dependent hybrid light bulb according to aspects of the present disclosure.

### DETAILED DESCRIPTION

Embodiments of the present disclosure will be described herein with reference to the accompanying drawings. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout. As used herein the term “and/or” includes any and all combinations of one or more of the associated listed items and may be abbreviated as “/”.

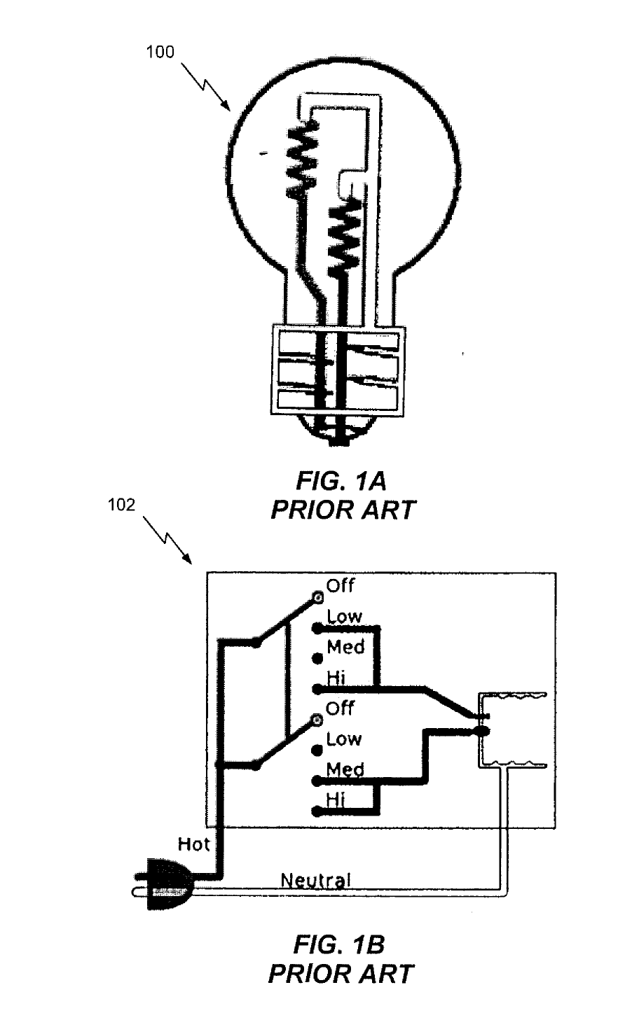

Multi-mode light bulbs are commonly used to provide light from more than one source. A common example of a multi-mode light bulb is a 3-way bulb such as the 3-way bulb 100 shown in FIG. 1A in which a medium wattage filament is energized to provide light in a first mode, a low wattage filament is energized to provide light in a second mode and both the medium wattage filament and the low wattage filament are energized to provide light in a third mode. As shown in FIG. 1B, a keyed 3-way socket 102 coupled to a two-way three circuit switch is commonly used to energize respective modes of a conventional 3-way bulb. According to one aspect of the present disclosure, the high wattage filament or the low wattage filament of a three way light bulb design is replaced by a compact florescent lamp (CFL) and CFL control circuitry, for example to construct a hybrid CFL/incandescent bulb. The hybrid CFL/incandescent bulb according to an aspect of the present disclosure may be configured for operation with a conventional 3 way socket to provide conventional 3 way operation in addition to temperature dependent operation, for example.

### Temperature Dependent Hybrid Light Bulb

Aspects of the present disclosure include hybrid light bulb that is configured to automatically select a low heat emitting (low power) mode such as a CFL bulb portion when ambient temperature is above a predetermined threshold, and to select a high heat emitting (conventional incandescent or halogen bulb) portion when ambient temperature is below the predetermined threshold.

According to aspects of the present disclosure a hybrid light bulb is configured for use in a conventional light socket. The hybrid light bulb includes a first portion and a second portion and switching circuitry configured to selectively couple either the first portion or the second portion to a power source. The switching circuitry may be located within the hybrid light bulb and the power source may be coupled to the switching circuitry in the same manner as it is coupled to a conventional light bulb, e.g. via the light socket for example. The first portion is configured as an energy saving light bulb and draws less current than the second portion. For example, the first portion may be a compact florescent lamp (CFL) bulb portion. The second portion may be configured as a conventional incandescent bulb or a halogen bulb, for example, which draws more current and emits more heat than the first portion. The switching circuitry may include temperature sensing circuitry to determine when to switch between coupling power to the first portion and coupling power to the second portion.

According to an aspect of the present disclosure, the switching circuitry may be configured to turn on the first portion (e.g. CFL portion) when ambient temperature around the bulb is above predetermined or configurable temperature, and alternatively to turn on the second (incandescent or other high heat emitting light mode such as halogen) portion when the ambient temperature is below the configurable or predetermined temperature. One or more temperature sensing components, such as a thermistor, for example may be configured in the switching circuitry to determine the ambient temperature. According to one aspect of the disclosure, the determination may be made before either portion of the hybrid light bulb is turned on to so that the selected portion is determined based on ambient temperature before the sensing component is influenced by heat emitted by the bulb.

In another embodiment, the temperature sensing components may be located some distance from the bulb. For example, sensing components may be coupled to the switching circuitry via a wire or conductive ribbon extending away from the bulb socket. A ribbon connector coupled to switching circuitry within the hybrid bulb may hang down from a lamp socket to a distance of at least several inches from the bulb, toward the base of a lamp for example. In yet another embodiment, temperature sensing circuitry could be located even further away from the hybrid bulb and may communicate wirelessly (either directly, or via a wireless network, for example) with switching circuitry in the bulb. When a sensor is located remotely from the bulb, it may provide an accurate ambient temperature measurement even during operation of the bulb. In such embodiments, the switching circuitry may be configured to switch between the first portion and the second portion during operation of the bulb. In this configuration, when the ambient temperature reaches a predetermined temperature, the switching circuitry turns off the second portion.

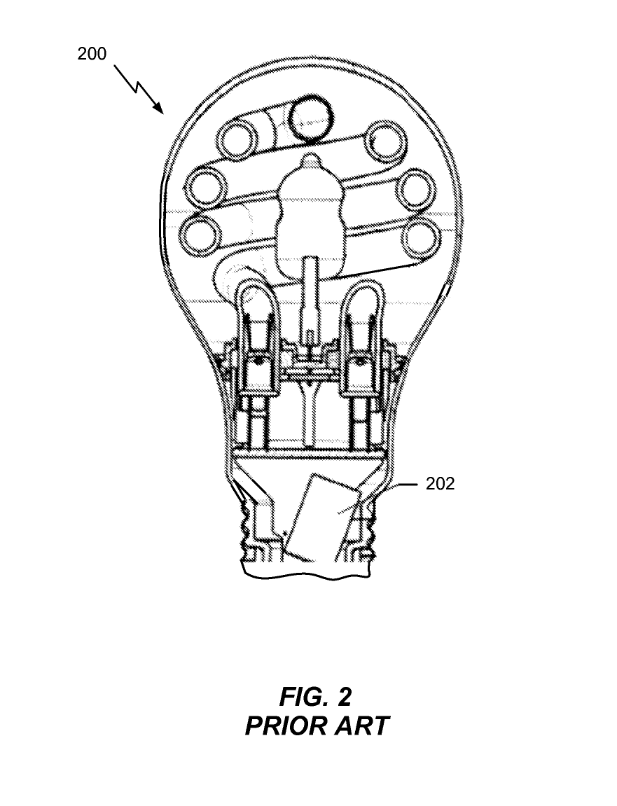

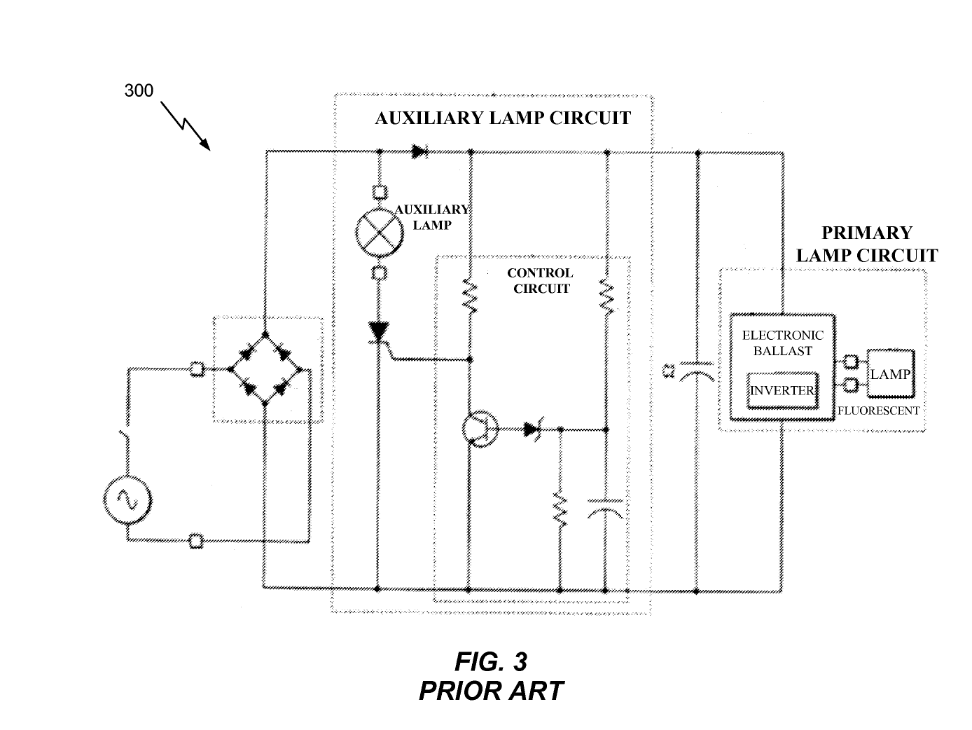

Examples of particular embodiments may include portions that are structurally similar to a previously known hybrid bulb as depicted in FIGS. 2-3. One such previously known hybrid bulb is called a Hybrid Halogen/CFL bulb that is currently marketed by General Electric Corporation (“the GE Hybrid bulb”). Referring to FIG. 2, a previous hybrid bulb 200 such as the GE Hybrid bulb is described in U.S. Patent Application Publication No. 2012/0187834 which is incorporated herein by reference. The previously known hybrid bulb 200 switches from a halogen bulb to a CFL bulb after a predetermined time period, which allows the CFL portion to energize and reach its operating light level. Timer based control circuitry 202 is configured for controlling the previously known hybrid bulb 200. A circuit diagram 300 of the timer based control circuitry 202 is shown in FIG. 3, for example.

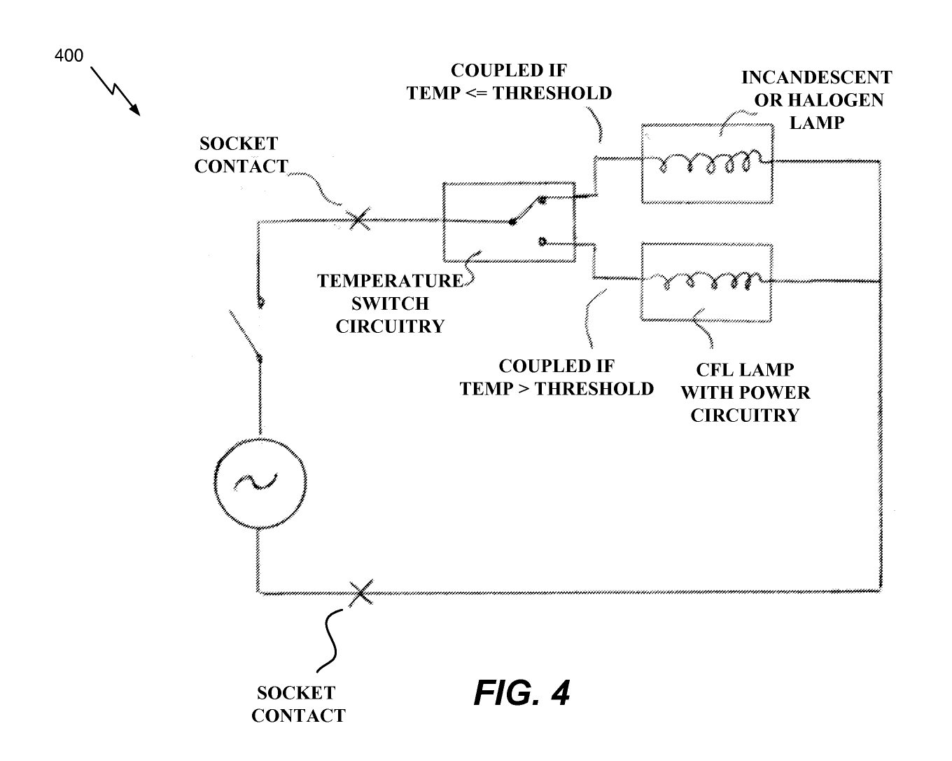

Unlike the previous hybrid bulb 200, rather than switching to CFL mode after a predetermined initial time, the presently disclosed device includes circuitry (400 FIG. 4) configured to switch from one light mode to another based on ambient temperature. According to an aspect of the present disclosure, temperature based control circuitry 400 may be incorporated in place of the timer based control circuitry 202 of a previously known hybrid bulb 200. The present disclosure provides a completely different use and configuration of a hybrid bulb that is not contemplated in previous hybrid bulbs 200 such as the GE Hybrid bulb, for example. Examples of hybrid bulbs according to aspects of the present disclosure could be constructed using much of the same equipment and techniques used to construct the previous hybrid lamp. However, according to aspects of the present disclosure control circuitry of the GE Hybrid bulb may be replaced by switching circuitry that is configured to select between low power modes and high power modes based on ambient temperature.

According to aspects of the present disclosure, in one configuration the mode switching circuitry includes a heat sensing and/or ambient temperature sensing element such as a thermistor, selected to inform mode switching circuitry with regard to switching modes at or around a predetermined ambient temperature. According to one aspect of the present disclosure, a hybrid bulb may be permanently configured to switch between power modes at a particular temperature. An example may be a “72 degree Fahrenheit hybrid bulb” in which switching circuitry is configured turn on the low power portion when the ambient temperature is above 72 degrees Fahrenheit and alternatively to turn on the high power portion when the ambient temperature is below 72 degrees Fahrenheit. A similar “80 degree Fahrenheit hybrid bulb” may be permanently configured similarly to switch between modes at a threshold temperature of 80 degrees Fahrenheit. According to another aspect of the disclosure, a hybrid bulb may include threshold adjusting circuitry that allows a user to adjust the threshold temperature of the bulb for switching between the high power mode and the low power mode, for example.

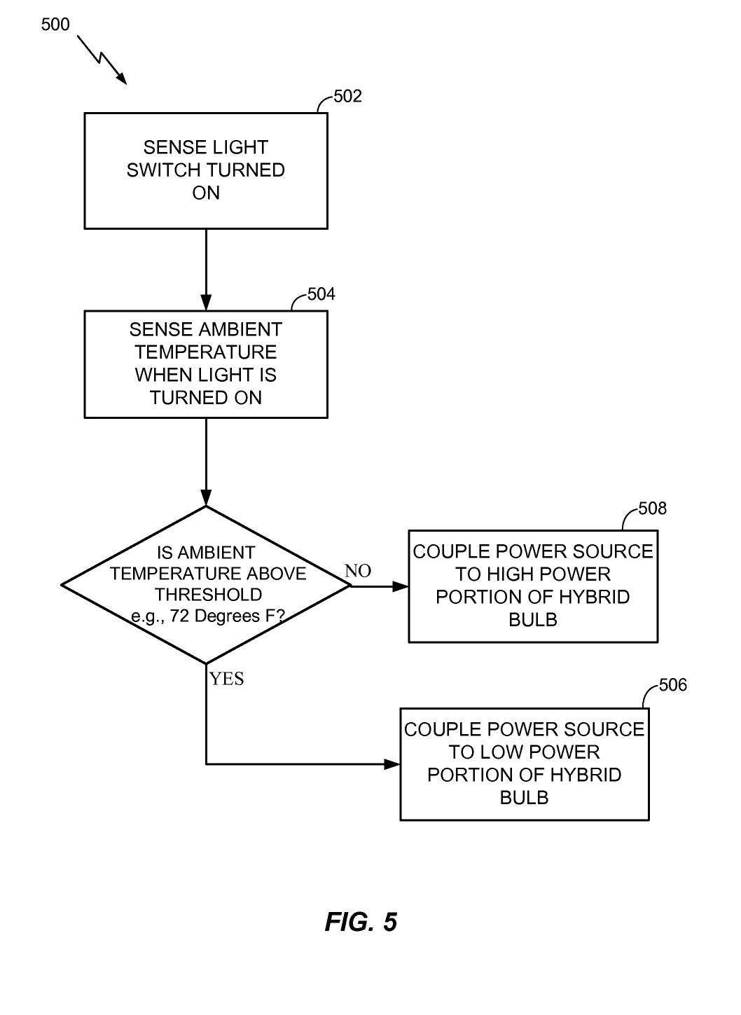

A method for providing an efficient light source according to aspects of the present disclosure is described with reference to FIG. 5. The method 500 includes sensing a transition of a light switch from an off state to an on state in block 502 and sensing an ambient temperature at block 504 in response to sensing the transition. At block 506, the method includes coupling a power source to a low power portion of a hybrid bulb in response to sensing that the ambient temperature is above a predetermined threshold temperature. At block 508, the method includes coupling a power source to a high power portion of the hybrid bulb in response to sensing that the ambient temperature is above a predetermined threshold temperature.

According to another aspect of the present disclosure, an apparatus for providing an efficient light source is disclosed. The apparatus includes means for sensing a transition of a light switch from an off state to an on state and means for sensing an ambient temperature in response to sensing the transition. The means for sensing the transition to on and means for sensing ambient temperature may be temperature sensing circuitry coupled to a power switch of a lamp. The temperature sensing circuitry may be located within a light bulb or external to the bulb, for example. The apparatus also includes means for coupling a power source to a low power portion of a hybrid bulb in response to sensing that the ambient temperature is above a predetermined threshold temperature and means for coupling a power source to a high power portion of the hybrid bulb in response to sensing that the ambient temperature is above a predetermined threshold temperature. The means for coupling a power source to the low power portion and means for coupling power source to the high power portion may be switching circuitry coupled to the temperature sensing circuitry, for example.

Controllable Light Bulb and/or Socket

According to another aspect of the present disclosure, a light bulb socket adapter may include a built in wireless (e.g. radio frequency (RF), infrared, wi-fi, etc.) receiver. The socket adapter may also include wireless controlled switch circuitry coupled to the receiver circuitry and configured to control light bulb (e.g. by opening and closing power circuit to the bulb, or varying phase or power to the bulb) in response to wireless commands received on the receiver circuitry. Wireless commands may be transmitted to the light bulb socket adapter using a portable transmitter which may be incorporated in a standard TV remote control, for example. The wireless receiver and transmitter may operate on a frequency that matches the frequency and/or other wireless communication parameters of a conventional TV remote control or programmable universal remote control so no special remote control transmitter may be needed. The light bulb socket adapter may include a male threaded portion for screwing into an existing light fixture, and a female threaded portion for accepting a conventional light bulb. Additional or alternative functionality may be added to circuitry within the socket adapter to measure or control usage of the light bulb.

Self Reporting Light Bulb and/or Socket Adapter and Internally Switched Light Bulb and/or Socket Adapter

A light bulb or socket adapter may include a bar code other or machine recognizable code. A smartphone and/or other computing device such as an iPhone having a camera portion may capture a digital image of the code and/or may read the machine recognizable code and identifies a corresponding frequency or modulation code for wireless control of the bulb or socket based on the bar code or machine recognizable code. The light bulb may include an internal switch and or brightness control circuitry controllable wirelessly e.g. by radio frequency such as Wi-Fi or blue tooth. The smartphone or device can then be used as a wireless controller to turn off lights etc. and/or to read the state of a light source (e.g. on or off). In some embodiments, relay circuitry may relay control signaling and/or state measurement signaling via a wireless router, for example to and/or from the bulb or socket adapter. A smart phone application (or computer program) running on a smart phone or computer configured for communicating with the bulb or socket can optionally label different bulbs by location, e.g. to show on a display, a diagram of a house with representations of light source states such as bulbs with names like “bedroom” “bathroom” “downstairs hall” being shown as on or off, for example. Optionally bulbs can be wirelessly interrogated to check state e.g. on/off/dimmed or watts being used, for example.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises,” “comprising,” “having,” “having,” “includes,” “including” and/or variations thereof, when used in this specification, specify the presence of stated features, steps, operations, elements, and/or components, but do not preclude the presence or addition of one or more other features, steps, operations, elements, components, and/or groups thereof.

It should be understood that when an element is referred to as being “connected” or “coupled” to another element (or variations thereof), it can be directly connected or coupled to the other element or intervening elements may be present. In contrast, when an element is referred to as being “directly connected” or “directly coupled” to another element (or variations thereof), there are no intervening elements present.

It should be understood that, although the terms first, second, etc. may be used herein to describe various elements and/or components, these elements and/or components should not be limited by these terms. These terms are only used to distinguish one element and/or component from another element and/or component. Thus, a first element or component discussed below could be termed a second element or component without departing from the teachings of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Although the present disclosure has been described in connection with the embodiments of the present disclosure illustrated in the accompanying drawings, it is not limited thereto. Persons with skill in the art will recognize that embodiments of the present disclosure may be applied to other types of memory devices. The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A hybrid lamp apparatus comprising:
a primary lamp circuit including a compact fluorescent lamp light source in a bulb;
a secondary lamp circuit including a conventional lamp light source in the bulb;
temperature dependent switching circuitry coupled to the primary lamp circuit and the secondary lamp circuit; and
temperature sensing circuitry coupled to the temperature dependent switching circuitry, the temperature dependent switching circuitry configured to couple a power source to either the primary lamp circuit or the secondary lamp circuit based on an ambient temperature sensed by temperature sensing circuitry.

2. The apparatus of claim 1, in which the conventional lamp light source is an incandescent lamp filament.

3. The apparatus of claim 1, in which the conventional lamp light source is a halogen lamp.

4. The apparatus of claim 1, further comprising:
a light switch coupled between the power source and the temperature dependent switching circuitry, in which the temperature dependent switching circuitry is configured to couple power to either the primary lamp circuit or the secondary lamp circuit based on the ambient temperature when the light switch is turned from an off state to on state.

5. The apparatus of claim 1, in which the temperature dependent switching circuitry is configured to automatically couple the power source to the primary lamp circuit when ambient temperature is above a predetermined threshold, and to automatically couple the power source to the secondary lamp circuit when the ambient temperature is above the predetermined threshold.

6. The apparatus of claim 1, in which the primary lamp circuit is configured as an energy saving light source.

7. The apparatus of claim 1, in which the primary lamp circuit draws less current than the secondary lamp circuit.

8. The apparatus of claim 1, configured for use in a conventional light socket.

9. The apparatus of claim 1, in which the temperature dependent switching circuitry is configured to couple the power source to the primary lamp circuit when ambient temperature at the bulb is above a configurable temperature and to couple the power source to the secondary lamp circuit when the ambient temperature at the bulb is below the configurable temperature.

10. The apparatus of claim 1, in which the temperature sensing circuitry is located remotely from the temperature dependent switching circuitry.

11. The apparatus of claim 10, in which the temperature sensing switching circuitry is in wirelessly linked to the temperature dependent switching circuitry.

12. A lighting method, comprising:
sensing ambient temperature by temperature sensing circuitry; and
coupling a power source to either a primary lamp circuit including a compact fluorescent lamp light source in a bulb or a secondary lamp circuit including a conventional lamp light source in the bulb based on the sensed ambient temperature.

13. The method of claim 12, further comprising:
automatically coupling the power source to the primary lamp circuit when ambient temperature is above a predetermined threshold, and automatically coupling the power source to the secondary lamp circuit when the ambient temperature is below the predetermined threshold.

14. The method of claim 12, further comprising:
coupling the power to either the primary lamp circuit or the secondary lamp circuit based on the ambient temperature in response to a light switch being switched from an off state to on state.

15. The method of claim 12 further comprising:
coupling the power source to the primary lamp circuit when ambient temperature at the bulb is above a configurable temperature and coupling the power source to the secondary lamp circuit when the ambient temperature at the bulb is below the configurable temperature.

16. A hybrid lamp apparatus comprising:
a primary lamp circuit including a first light source in a bulb;
a secondary lamp circuit including a second light source in the bulb;
temperature dependent switching circuitry coupled to the primary lamp circuit and the secondary lamp circuit; and
temperature sensing circuitry coupled to the temperature dependent switching circuitry, the temperature dependent switching circuitry configured to couple a power source to either the primary lamp circuit or the secondary lamp circuit based on an ambient temperature sensed by temperature sensing circuitry.

17. A lighting control apparatus, comprising:
a light bulb socket portion configured for receiving a conventional light bulb base;
a base portion configured for installing in a conventional light socket; and
switching circuitry configured between the light bulb socket portion and the base portion.

18. The apparatus of claim 17, in which the switching circuitry is configured to couple a power source to either a primary lamp circuit or a secondary lamp circuit of a light bulb installed in the light bulb socket portion.

19. The apparatus of claim 18, in which the switching circuitry comprises:
temperature dependent switching circuitry configured to automatically couple the power source to the primary lamp circuit when ambient temperature is above a predetermined threshold, and to automatically couple the power source to the secondary lamp circuit when the ambient temperature is above the predetermined threshold

20. The apparatus of claim 17, comprising:
a built in wireless receiver coupled to the switching circuitry; and
the switching circuitry comprising a wireless controlled switch circuit coupled to the wireless receiver circuitry, in which the wireless controlled switch circuit is configured to control a light bulb in response to wireless commands received on the receiver circuitry.
